(19) United States
(12) Patent Application Publication
(10) Pub. No.: US 2021/0331690 A1
(43) Pub. Date: Oct. 28, 2021

(54) SYSTEMS AND METHODS FOR NOTIFYING A USER DURING AUTONOMOUS DRIVING

(71) Applicant: Toyota Motor Engineering & Manufacturing North America, Inc., Plano, TX (US)

(72) Inventors: Jeffrey E. Pierfelice, Canton, MI (US); Elliott Y. Vega, Ypsilanti, MI (US)

(73) Assignee: Toyota Motor Engineering & Manufacturing North America, Inc., Plano, TX (US)

(21) Appl. No.: 16/855,652

(22) Filed: Apr. 22, 2020

(51) Int. Cl. B60W 50/14; B60W 60/00; G05D 1/00; H04W 68/00; H04W 4/40

(52) U.S. Cl. CPC B60W 50/14; B60W 60/0054; B60W 60/0059; B60W 2050/146; G05D 1/0016; H04W 68/005; H04W 4/40; G05D 1/0061

(57) ABSTRACT

Embodiments herein are directed to a vehicle. The vehicle includes a communication device and an autonomous vehicle controller. The autonomous vehicle controller is communicatively coupled to the communication device. The autonomous vehicle controller is configured to operate the vehicle in between an autonomous driving mode and a manual driving mode. The autonomous vehicle controller includes one or more processors, one or more memory modules communicatively coupled to the one or more processors, and machine readable instructions stored in the one or more memory modules. The machine readable instructions cause the autonomous vehicle controller to perform at least the following when executed by the one or more processors: operate the vehicle in the autonomous driving mode, obtain a vehicle environment information, determine whether an event is required based on the vehicle environment information, and alert the communication device of the event.

### TECHNICAL FIELD

Embodiments described herein generally relate to systems for alerting a driver and, more specifically, to systems for alerting a driver during an autonomous driving mode based on an occurrence of an event.

### BACKGROUND

Current vehicles may have two modes of operation. Namely, a manual driving mode, in which the vehicle is controlled manually by a human driver, and autonomous driving mode, in which the vehicle is controlled autonomously by a vehicle system. When the vehicle is in the autonomous mode, a controller may provide notifications to a user through a vehicle head unit or a recorded message through a vehicle's audio system. However, because the vehicle is in autonomous mode, users are likely to be focused on their personal electronic device, such as a mobile smart phone device, tablet, laptop, and the like. For example, during autonomous driving, the user may be watching videos on the personal electronic device and/or listening to content on the personal electronic device through headphones. As such, a visual message on the vehicle head unit or the recorded message through the vehicle's audio system may not effectively convey the notification or alert to the user.

### SUMMARY

In one embodiment, the vehicle is provided. The vehicle includes a communication device and an autonomous vehicle controller. The autonomous vehicle controller is communicatively coupled to the communication device. The autonomous vehicle controller is configured to operate the vehicle in between an autonomous driving mode and a manual driving mode. The autonomous vehicle controller includes one or more processors, one or more memory modules communicatively coupled to the one or more processors, and machine readable instructions stored in the one or more memory modules. The machine readable instructions cause the autonomous vehicle controller to perform at least the following when executed by the one or more processors: operate the vehicle in the autonomous driving mode, obtain a vehicle environment information, determine whether an event is required based on the vehicle environment information, and alert the communication device of the event.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a vehicle having a vehicle system according to one or more embodiments shown and described herein;

FIG. 2A schematically depicts illustrative hardware components of an autonomous controller that may be used in generating notifications to a communication device of a user according to one or more embodiments shown and described herein;

FIG. 2B schematically depicts an illustrative memory component containing illustrative logic components according to one or more embodiments shown and described herein;

FIG. 2C schematically depicts an illustrative data storage device containing illustrative data components according to one or more embodiments shown and described herein; and

FIG. 3 depicts a flow diagram of an illustrative method of generating a notification of an event to a communication device of a user based on an event according to one or more embodiments shown and described herein.

### DETAILED DESCRIPTION

The embodiments disclosed herein include vehicle systems that alert or notify a user via a personal electronic device of an event when the vehicle is in an autonomous mode. For example, an event may be generated when an autonomous controller determines that continuing to drive in autonomous mode is undesirable and alerts or notifies a user to prepare to accept a vehicle control. In another example, the event is generated to transfer navigational information to the user via the personal electronic device. The navigational information may include a vehicle's estimated time of arrival at a certain destination is being extended because of traffic, when the vehicle opts to take a different navigational route to avoid an accident or traffic jam, and the like. In yet another example, the event is generated to transfer a plurality of statuses pertaining to an exterior surrounding of the vehicle and/or internal operations of the vehicle.

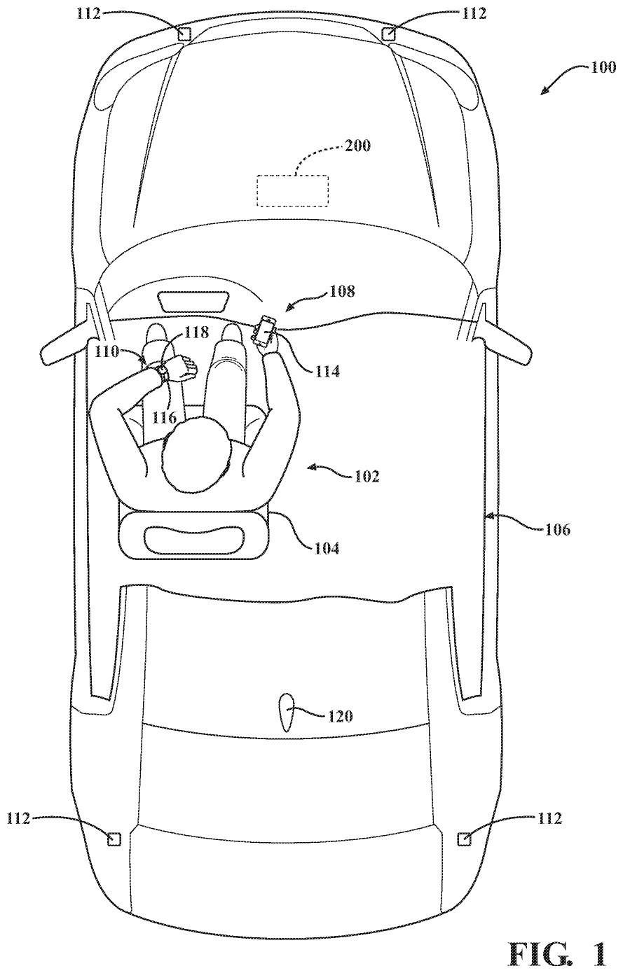

FIG. 1 schematically depicts a vehicle 100. The vehicle 100 may be an automobile or any other passenger or non-passenger vehicle such as, for example, a terrestrial, aquatic, and/or airborne vehicle. The vehicle 100 includes an autonomous vehicle controller 200 and a plurality of sensors 112. The autonomous vehicle controller 200 is configured to transfer vehicle control between a manual mode and an autonomous mode. In the manual mode, the vehicle 100 is controlled by a human driver. In the autonomous mode, the vehicle 100 is controlled by the autonomous vehicle controller 200 to navigate its environment with limited human input or without human input. In the autonomous mode, a user 102 may be positioned within a driver seat 104 of a passenger cabin 106 of the vehicle 100. The user 102 does not have vehicle control and instead may be focused on a communication device 108, a wearable device 110, and the like. In some embodiments, the system may be embedded within a mobile device (e.g., smartphone, laptop computer, etc.) carried by a driver of the vehicle 100. In embodiments, the vehicle 100 includes a plurality of sensors 112.

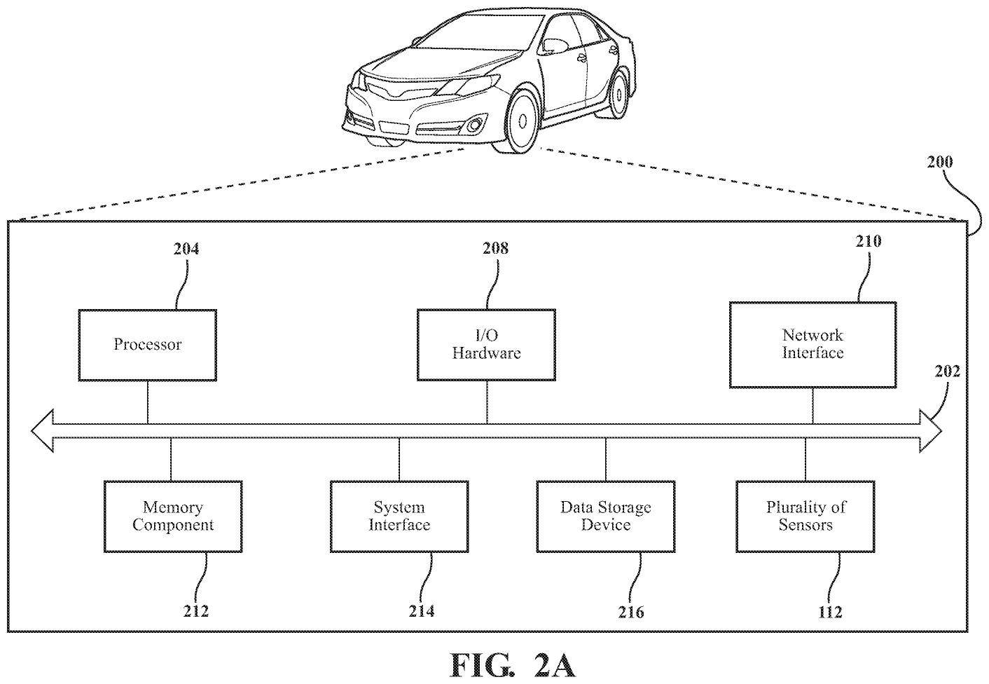

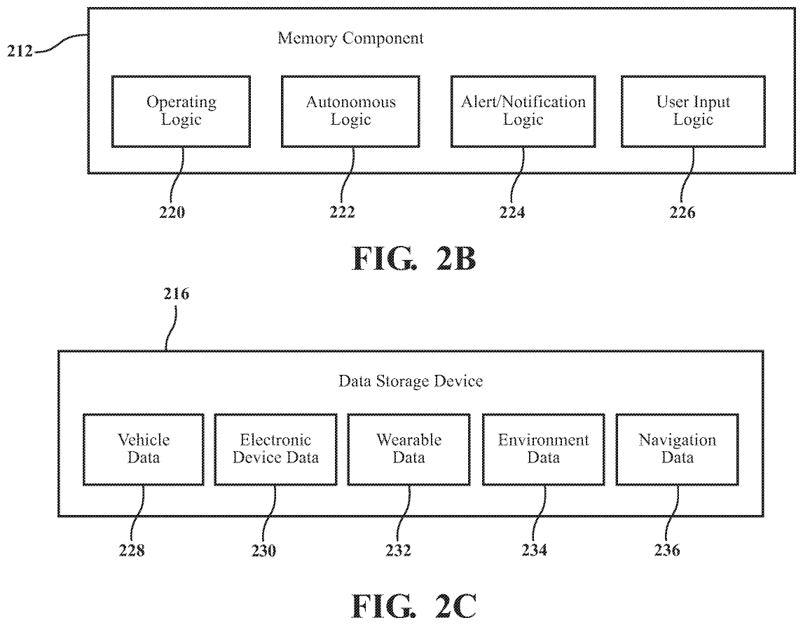

The plurality of sensors 112, for example, monitor vehicle environment information. As described in greater detail herein, the various sensors may also generally be used to sense a vehicle data, a navigational data, a plurality of vehicle statuses relating to the vehicle environment information and/or an internal operation of the vehicle to determine when an event may occur to notify or alert the user 102 via the communication device 108 and/or the wearable device 110, based on the sensed data. As such, it should be appreciated that the vehicle environment information may include data relating to detecting a particular condition or situation that may cause the vehicle 100 to be undesirable for autonomous driving such as crash prevention, weather related, and the like. As discussed in greater detail below, the vehicle data 228 (FIG. 2C) may include actual vehicle data such as a current speed, current vehicle control, and the like, as well as a plurality of vehicle statuses relating to internal operation data of the vehicle 100. The navigation data 236 (FIG. 2C) may include data related to the current vehicle location, traffic information, destination information, routing information, current speed limits and the like. The environmental data 23 (FIG. 2C) includes data relating to a vehicle exterior surroundings such as to detecting objects surrounding the vehicle, for example, pedestrians, other vehicles, buildings, light poles, curbs, the road and the like and detecting in-vehicle operations such as audio volume, heating and cooling, and the like.

The plurality of sensors 112 may transmit a plurality of outputs, either wired or wirelessly, to the autonomous vehicle controller 200, as explained in greater detail herein. The plurality of sensors 112 may include laser scanners, capacitive displacement sensors, Doppler effect sensors, eddy-current sensors, ultrasonic sensors, magnetic sensors, optical sensors, radar sensors, sonar sensors, LIDAR sensors, any combination thereof, and/or any other type of sensor that one skilled in the art may appreciate.

The communication device 108 may be configured to interact with the autonomous vehicle controller 200. In some embodiments, the communication device 108 is paired with the autonomous vehicle controller 200 of the vehicle 100 via a wired connection and/or a wireless connection. The communication device 108 may be a smart mobile device such as a smart phone, a laptop, a tablet, or a like portable handheld smart device. The communication device 108 may include a display 114, a processor, a memory communicatively coupled to the processor, and machine readable instructions stored in the memory. The machine readable instructions may cause the display 114 to, when executed by the processor, launch and operate an alert and/or notification pushed from the autonomous vehicle controller 200 to the communication device 108, as discussed in greater detail herein.

The wearable device 110 may be configured to interact with the autonomous vehicle controller 200. In some embodiments, the wearable device 110 is paired with the autonomous vehicle controller 200 of the vehicle 100 via a wired connection and/or a wireless connection. The wearable device 110 may be a smart mobile device such as a smart watch, smart glasses, or a like portable wearable smart device. In some embodiments, the wearable device 110 may be worn be the user. For example, the wearable device 110 may be mounted to an arm strap 116 or other band/article that may be worn by the user. The wearable device 110 may include a display 118, a processor, a memory communicatively coupled to the processor, and machine readable instructions stored in the memory. The machine readable instructions may cause the display 118 to, when executed by the processor, launch and operate an alert and/or notification pushed from the autonomous vehicle controller 200 to the wearable device 110, as discussed in greater detail herein.

FIG. 2A schematically depicts illustrative hardware components of the vehicle 100 that may be used to notify the communication device 108 and/or the wearable device 110 when the vehicle 100 is in the autonomous mode. The vehicle 100 may include the autonomous vehicle controller 200 having a non-transitory computer-readable medium storing computer-readable programming instructions for completing the various processes described herein, embodied as hardware, software, and/or firmware, according to embodiments shown and described herein. While in some embodiments the autonomous vehicle controller 200 may be configured as a general purpose computer with the requisite hardware, software, and/or firmware, in other embodiments, the autonomous vehicle controller 200 may also be configured as a special purpose computer designed specifically for performing the functionality described herein. For example, the autonomous vehicle controller 200 may be a device that is particularly adapted to obtain the vehicle environment information, determine whether an event is required based on the vehicle environment information, and alert the communication device 108 and/or wearable device 110 of the event. In another example, the event is a manual takeover event based on the vehicle environment information in which the manual takeover event transfers the vehicle operation from the autonomous driving mode to the manual driving mode and the alert notifies the user 102 of the vehicle to be prepared for the manual takeover event prior to the transfer of the vehicle control from the autonomous driving mode to the manual driving mode. In embodiments where the autonomous vehicle controller 200 is a general purpose computer, the systems and methods described herein provide a mechanism for improving vehicle control functionality by obtaining the vehicle environment information, determining whether an event is required based on the vehicle environment information, and alerting the communication device 108 and/or wearable device 110 of the event.

Still referring to FIG. 2A, the autonomous vehicle controller 200 may generally be an onboard vehicle computing system. In some embodiments, the autonomous vehicle controller 200 may be a plurality of vehicle computing systems. As also illustrated in FIG. 2A, the autonomous vehicle controller 200 may include a processor 204, an I/O hardware 208, a network interface hardware 210, a non-transitory memory component 212, a system interface 214, a data storage device 216, and the plurality of sensors 112. A local interface 202, such as a bus or the like, may interconnect the various components.

It should be understood that the local interface 202 may be formed from any medium that is capable of transmitting a signal such as, for example, conductive wires, conductive traces, optical waveguides, or the like. In some embodiments, the local interface 202 may facilitate the transmission of wireless signals, such as Wi-Fi, Bluetooth, Near Field Communication (NFC) and the like. Further, it should be appreciated that the local interface 202 may communicatively couple the communication device 108 and/or the wearable device 110 to the autonomous vehicle controller 200. Moreover, the local interface 202 may be formed from a combination of mediums capable of transmitting signals. In one embodiment, the local interface 202 comprises a combination of conductive traces, conductive wires, connectors, and buses that cooperate to permit the transmission of electrical data signals to components such as processors, memories, sensors, input devices, output devices, and communication devices. Accordingly, the local interface 202 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The processor 204, such as a computer processing unit (CPU), may be the central processing unit of the autonomous vehicle controller 200, performing calculations and logic operations to execute a program. The processor 204, alone or in conjunction with the other components, is an illustrative processing device, computing device, processor, or combination thereof. The processor 204 may include any processing component configured to receive and execute instructions (such as from the data storage device 216 and/or the memory component 212).

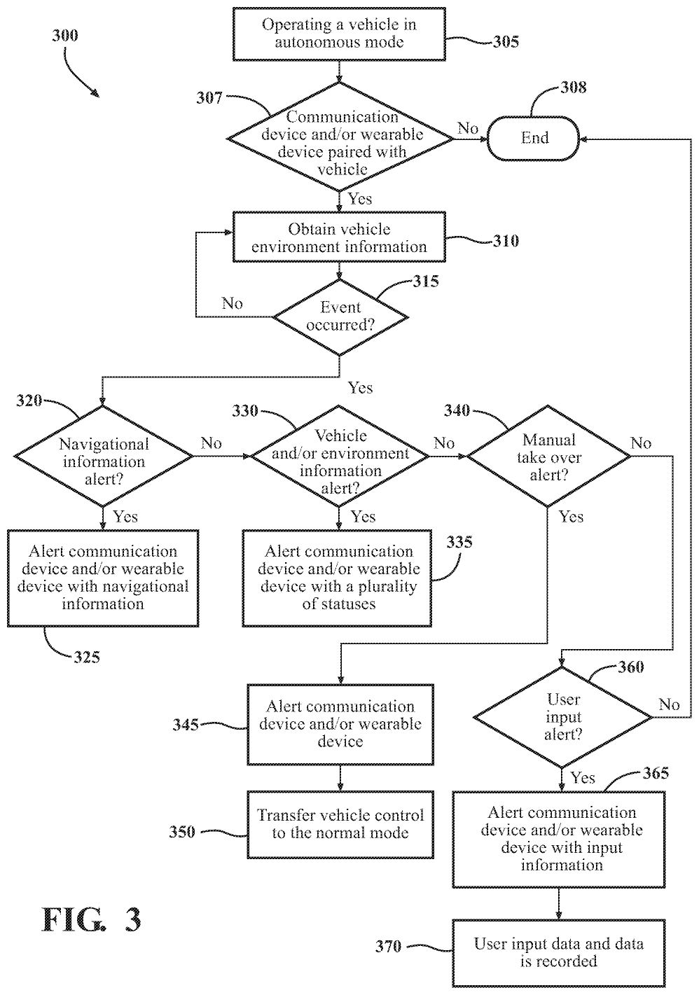

The memory component 212 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory component 212 may include one or more programming instructions thereon that, when executed by the processor 204, cause the processor 204 to complete various processes, such as the processes described herein with respect to FIG. 3. Still referring to FIG. 2A, the programming instructions stored on the memory component 212 may be embodied as a plurality of software logic modules, where each logic module provides programming instructions for completing one or more tasks, as described in greater detail below with respect to FIG. 2B.

The network interface hardware 210 may include any wired or wireless networking hardware, such as a modem, a LAN port, a wireless fidelity (Wi-Fi) card, WiMax card, mobile communications hardware, a satellite antenna 120 (FIG. 1), and/or other hardware for communicating with other networks and/or devices. For example, the network interface hardware 210 may provide a communications link between the vehicle 100 and the other components of a network such as satellites, user computing devices, server computing devices, and the like. That is, in embodiments, the network interface hardware 210 is configured to receive signals from global positioning system satellites and includes one or more conductive elements that interact with electromagnetic signals transmitted by global positioning system satellites. The received signal is transformed into a data signal indicative of the location (e.g., latitude and longitude) of the network interface hardware 210 or an object positioned near the network interface hardware 210 by the processor 204. Thus, the network interface hardware 210 allows the vehicle 100 to monitor its location.

Still referring to FIG. 2A, the data storage device 216, which may generally be a storage medium, may contain one or more data repositories for storing data that is received and/or generated. The data storage device 216 may be any physical storage medium, including, but not limited to, a hard disk drive (HDD), memory, removable storage, and/or the like. While the data storage device 216 is depicted as a local device, it should be understood that the data storage device 216 may be a remote storage device, such as, for example, a server computing device or the like. Illustrative data that may be contained within the data storage device 216 is described below with respect to FIG. 2C. It should be appreciated that the amount of available storage space in the data storage device 216 may be limited due to its location in the autonomous vehicle controller 200 in some embodiments. As such, it may be necessary to minimize the size of the data stored thereon, as described in greater detail herein.

Still referring to FIG. 2A, the I/O hardware 208 may communicate information between the local interface 202 and one or more other components of the vehicle 100. For example, the I/O hardware 208 may act as an interface between the autonomous vehicle controller 200 and other components, such as the plurality of sensors 112, the communication device 108 (FIG. 1), the wearable device 110 (FIG. 1), navigation systems, meter units, infotainment systems, and/or the like. In some embodiments, the I/O hardware 208 may be utilized to transmit one or more commands to the other components of the vehicle 100.

The system interface 214 may generally provide the autonomous vehicle controller 200 with an ability to interface with one or more external devices such as, for example, the communication device 108 (FIG. 1) and/or the wearable device 110 (FIG. 1), such that the autonomous vehicle controller 200 may push a notification or alert to the communication device 108 (FIG. 1) and/or the wearable device 110 (FIG. 1).

Still referring to FIG. 2A, the plurality of sensors 112 may be communicatively coupled to the local interface 202 and communicatively coupled to the processor 204 via the local interface 202. As used herein, the term “communicatively coupled” means that coupled components are capable of exchanging data signals with one another such as, for example, electrical signals via conductive medium, electromagnetic signals via air, optical signals via optical waveguides, and the like. The plurality of sensors 112 may be any sensing device, sensor, or detector that is suitable for obtaining or collecting data. Any suitable commercially available plurality of sensors 112 may be used without departing from the scope of the present disclosure. In some embodiments, the plurality of sensors 112 may be coupled to one or more other components that provide additional functionality for sensing, such as, for example, an image capturing device that captures images, whether still or video (a sequence of dynamic photos).

With reference to FIG. 2B, in some embodiments, the program instructions contained on the memory component 212 may be embodied as a plurality of software modules, where each module provides programming instructions, machine readable and executable instructions, and/or the like, for completing one or more tasks. The programming instructions, machine readable and executable instructions, and the like may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, and the like, that may be compiled or assembled into machine readable and executable instructions and stored on the one or more memory component 212. Alternatively, the programming instructions, machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

For example, FIG. 2B schematically depicts the memory component 212 containing illustrative logic components according to one or more embodiments shown and described herein. As shown in FIG. 2B, the memory component 212 may be configured to store various processing logic, such as, for example, an operating logic 220, an autonomous driving logic 222, an alert/notification logic 224 and/or an user input logic 226 (each of which may be embodied as a computer program, firmware, or hardware, as an example).

Still referring to FIG. 2B, the operating logic 220 may include an operating system and/or other software for managing components of the autonomous vehicle controller 200 (FIG. 2A). Further, the operating logic 220 may contain one or more software modules for monitoring data, transmitting data, and/or analyzing data. The autonomous driving logic 222 may contain one or more software modules and/or other software for managing components of the autonomous vehicle controller 200 (FIG. 2A). Further, the autonomous driving logic 222 may contain one or more software modules for monitoring data, transmitting data, and/or analyzing data, collecting data and/or determining when the vehicle control should be changed from the autonomous mode to the manual mode. The autonomous driving logic 222 may collect data from one or more sources (e.g. the plurality of vehicle sensors 112 depicted in FIG. 1, and/or the like), as described in greater detail herein. The alert/notification logic 224 may contain one or more software modules for receiving data, monitoring data, transmitting data, and/or analyzing data to provide the communication device 108 (FIG. 1) and/or the wearable device 110 (FIG. 1) with the alert/notification. The user input logic 226 may contain one or more software modules for receiving data from the user 102 to provide a change or modification in the vehicle such as a change in speed or a change in the cabin temperature.

FIG. 2C schematically depicts a block diagram of various data contained within a storage device (e.g., the data storage device 216). As shown in FIG. 2C, the data storage device 216 may include, for example, a plurality of vehicle data 228, such as current speed, current operating conditions, interior statuses such as cabin temperature, and the like. The plurality of vehicle data 228 may be received from vehicle components, such as the navigation system, data gathered by autonomous vehicles sensors, data gathered by the plurality of sensors 112 (FIG. 1), and the like. For example, data gathered from the autonomous vehicles sensors, data gathered by the plurality of sensors 112 (FIG. 1), and the like, and the autonomous vehicle controller 200 may monitor the speed of the vehicle 100, and initiate an event to generate the alert/notification to the user 102 via the communication device 108 (FIG. 1) and/or the wearable device 110 (FIG. 1). For example, if the vehicle speed is 80 mph and the autonomous vehicle controller 200 identifies that the current speed limit is 60 mph (e.g., by capturing and processing a speed limit sign, retrieving pre-stored speed limit information from the one or more software modules of the memory component 212 such as the autonomous driving logic 222 or from a remote server), the autonomous vehicle controller 200 may initiate the event and generate the alert/notification to the communication device 108 (FIG. 1) and/or the wearable device 110 (FIG. 1). In some embodiments, the alert/notification may inform the user 102 (FIG. 1) of the deviation in speed. In other embodiments, the alert/notification may inform the user 102 (FIG. 1) that a manual take-over will occur to transfer the vehicle control from the autonomous driving mode into the manualdriving mode. That is, a manual takeover may occur when an undesirable condition is determined, such as speeding, following too close, and generally undesirable driving practices. It should be appreciated that the plurality of vehicle data 228 may not be stored permanently, but instead may be stored temporarily such that the data may be extracted therefrom.

The data storage device 216 may further include, for example, a plurality of electronic device data 230, such as the type of device (e.g., whether the device is the communication device 108 (FIG. 1) and the like), the connectivity of the device, the type of the display (e.g., the display 114 of the communication device 108 (FIG. 1)) such as whether the display is an optical output such as, for example, a cathode ray tube, a light emitting diode (LED) display, an organic light emitting diode (OLED) display, a liquid crystal display, a plasma display, and/or the like. Further, the plurality of electronic device data 230 may include information relating to the operating system of the communication device 108 (FIG. 1) such that the alert/notification may be pushed to the communication device 108 (FIG. 1).

The data storage device 216 may further include, for example, a plurality of wearable device data 232, such as the type of device (e.g., whether the device is the wearable device 110 (FIG. 1) and the like), the connectivity of the device, the type of display (e.g., the display 118 of the wearable device 110 (FIG. 1)), and the like such as whether the display is an optical output such as, for example, a cathode ray tube, a light emitting diode (LED) display, an organic light emitting diode (OLED) display, a liquid crystal display, a plasma display, and/or the like. Further, the plurality of wearable device data 232 may include information relating to the operating system of the wearable device 110 (FIG. 1) such that the alert/notification may be pushed to the wearable device 110 (FIG. 1).

The data storage device 216 further includes a plurality of environment data 234, which may be received from the plurality of sensors 112 (FIG. 1), as discussed in greater detail herein. The plurality of sensors 112 (FIG. 1) are positioned within the vehicle 100 may capture data such as images of the vehicle surroundings. It should be appreciated that any image processing technology may be used to process images from the plurality of sensors 112.

In some embodiments, the plurality of sensors 112 (FIG. 1) detect a distance between the plurality of sensors 112 (FIG. 1) and an object nearby and communicate the proximity information to the autonomous vehicle controller 200 of the vehicle 100. The plurality of sensors 112 (FIG. 1) may be any device capable of outputting a proximity signal indicative of the proximity of an object to the plurality of sensors 112 (FIG. 1). Some embodiments may not include the plurality of sensors 112 (FIG. 1). In some embodiments, the vehicle 100 may be configured to determine the presence of an obstacle proximate to the vehicle 100 based on a signal from the plurality of sensors 112 (FIG. 1). Based on the identified obstacle, the autonomous vehicle controller 200 may determine whether an undesirable condition is present. Then, the autonomous vehicle controller 200 may determine whether or not to initiate an alert/notification to be pushed to the user via the communication device 108 (FIG. 1) and/or wearable device 110 (FIG. 1).

In some embodiments, the plurality of sensors 112 (FIG. 1) may include a temperature sensor for sensing a temperature outside the vehicle, a moisture sensor for sensing a humidity outside the vehicle, a fog detector sensor, a rain sensor, a snow sensor, and the like. Based on outputs from the plurality of sensors 112 (FIG. 1), the autonomous vehicle controller 200 may determine whether or not an event has occurred and, if so, whether to push an alert/notification to the user via the communication device 108 (FIG. 1) and/or wearable device 110 (FIG. 1). For example, if the autonomous vehicle controller 200 receives outputs from the snow detector sensor, the autonomous vehicle controller 200 may initiate an event, notify/alert the user 102 (FIG. 1) that the event is a takeover event and then transfer vehicle control from the autonomous driving mode to the manual driving mode, as discussed in greater detail herein.

The memory component 212 may include instructions for processing images, data, signals, and the like received from the plurality of sensors 112 (FIG. 1). For example, the processor 204 may implement the instructions in the memory component 212 to process an image from the plurality of sensors 112 (FIG. 1) to identify an object on the road, a speed limit sign, and the like. As such, the plurality of sensors 112 (FIG. 1) may capture images and/or data of objects external to the vehicle 100 (FIG. 1). For example, the processor 204 implement the instructions in the memory component 212 to process the data and/or image from the plurality of sensors 112 (FIG. 1) to identify any obstacles proximate to the vehicle 100. Based on the identified obstacles, the autonomous vehicle controller 200 (FIG. 2) may determine whether an event has occurred. That is, based on the identified objects surrounding the vehicle 100 (FIG. 1), the autonomous vehicle controller 200 (FIG. 2) may determine whether or not an event has occurred and, if so, push the alert/notification to the communication device 108 (FIG. 1) and/or wearable device 110 (FIG. 1), as discussed in greater detail herein. For example, if the identified object creates an undesirable condition, the event generated may be a takeover event and the alert/notification is pushed to the communication device 108 (FIG. 1) and/or wearable device 110 (FIG. 1) to notify the user to prepare for the manual takeover of vehicle control.

The data storage device 216 may further include, for example, a plurality of navigation data 236 such as a current location of the vehicle 100 (FIG. 1), a current traffic condition, a current destination, and the like. In some embodiments, the plurality of navigation data 236 may also include route options between a current location and a destination, and retrieve traffic information for the route options. As such, for example, if the current route follows a heavy traffic route, the autonomous vehicle controller 200 may generate an event to alert/notify the user 102 (FIG. 1) of a deviation from the current route to an alternative route with less traffic and/or of a delay in an expected arrival time.

It should be understood that the components illustrated in FIGS. 2A-2C are merely illustrative and are not intended to limit the scope of this disclosure. More specifically, while the components in FIGS. 2A-2C are illustrated as residing within the autonomous vehicle controller 200 of the vehicle 100, this is a non-limiting example. In some embodiments, one or more of the components may reside external to the autonomous vehicle controller 200 and/or the vehicle 100.

As mentioned above, the various components described with respect to FIGS. 2A-2C may be used to carry out one or more processes and/or produce data that can be used to push the alert/notification to the wearable device 110 (FIG. 1) and/or the communication device 108 (FIG. 1) to notify the user of the event.

FIG. 3 depicts an illustrative method 300 for alerting/notifying the user of an event. In block 305, the vehicle is operating in the autonomous mode. That is, the vehicle control is non-human. At block 307, the user pairs the communication device and/or wearable device with the vehicle and in particular with the autonomous vehicle controller. It should be understood that this pairing may be performed through a plurality of methods, such as using applications, in vehicle wireless conductivity, and the like, as will be readily apparent to those skilled in the art. If the communication device and/or wearable device are not paired with the vehicle, the process 300 ends at block 308. Once paired, during vehicle operations, the plurality of sensors continuously obtain vehicle environment information, at block 310. Vehicle environment information may include a plurality of information such as information related to the exterior vehicle surroundings, information about the vehicle's location, destination, and routes, information about the onboard vehicle status, current vehicle information, and the like. At block 315, the autonomous vehicle controller monitors the vehicle environment information to determine whether an event occurred. If an event has not occurred, the plurality of sensors continuously obtain vehicle environment information, at block 310.

If an event has occurred, the autonomous vehicle controller determines whether the event at block 315 should generate a navigational information alert at block 320, a vehicle and/or environment information alert at block 330, a manual takeover alert at block 340 and/or a user input alert at block 360. It should be appreciated that while the process 300 illustrates that the autonomous vehicle controller determines each of these in a successive or progression, this is for illustrative purposes only and may exclude, for example, block 320 and/or block 330 and go right to block 340, and so on. Further, it should be appreciated that more than one may be selected to alert the user. For example, the vehicle and/or environment information alert at block 330 and the user input alert at block 360 may independently, successively and/or simultaneously alert the user.

When the autonomous vehicle controller determines to generate a navigational information alert at block 320, the autonomous vehicle controller pushes the alert/notification to the communication device and/or wearable device to provide information to the user at block 325. For example, the information may include navigational information related to vehicle expected time of arrival at a destination, delays to the expected time of arrival due to heavy traffic and the like, the determination of the autonomous vehicle controller to take an alternate navigational routes, for instance to avoid an accident or a traffic jam, and the like.

When the autonomous vehicle controller determines to generate the vehicle and/or environment information alert at block 330, the autonomous vehicle controller pushes the alert/notification to the communication device and/or wearable device to provide information to the user at block 335. For example, the information may include a plurality of statuses pertaining to the vehicle's exterior surroundings or the vehicle's internal operations.

When the autonomous vehicle controller determines to generate the manual takeover alert at block 340, the autonomous vehicle controller pushes the alert/notification to the communication device and/or wearable device to provide information to the user at block 345. The autonomous vehicle controller may determine to generate the manual takeover alert when a particular condition or situation is detected which may require the user to act in some manner. For instance, the user may be required to manually take control of the vehicle. In some embodiments, the particular condition or situation may be in bad weather conditions, when communication between the vehicle and satellites is less than optimal, when undesirable conditions are present, and the like. When the autonomous vehicle controller determines to generate the manual take-over alert at block 340 and the alert/notification is pushed to the communication device and/or wearable device to alert/notify the user at block 345, then the autonomous vehicle controller may transfer vehicle control from the autonomous mode into the manual mode. As such, the user becomes a driver of the vehicle.

When the autonomous vehicle controller determines to generate the user input alert at block 360, the autonomous vehicle controller pushes the alert/notification to the communication device and/or wearable device to provide information to the user at block 365. The autonomous vehicle controller may determine wait to receive an input from a user that may change the current vehicle data and/or interior condition at block 370. For example, the user may input a specific function to increase or decrease a speed of the vehicle when there is a speed limit change, to override the autonomous vehicle mode, and the like.

According to the present subject matter, because the autonomous vehicle controller obtains vehicle environment information while the vehicle is in the autonomous vehicle mode, an event may be generated which causes an alerts/notification to be sent to the user via the communication device and/or wearable device such that the user's attention may be garnered.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A vehicle comprising:
a communication device; and
an autonomous vehicle controller communicatively coupled to the communication device, wherein the autonomous vehicle controller is configured to operate the vehicle in an autonomous driving mode and a manual driving mode, and the autonomous vehicle controller comprises:
one or more processors;
one or more memory modules communicatively coupled to the one or more processors; and
machine readable instructions stored in the one or more memory modules that cause the autonomous vehicle controller to perform at least the following when executed by the one or more processors:
operate the vehicle in the autonomous driving mode;
obtain a vehicle environment information;
determine whether an event is required based on the vehicle environment information; and
alert the communication device of the event.

2. The vehicle of claim 1, wherein:
the event is a manual take-over event based on the vehicle environment information, and
the manual takeover event transfers a vehicle operation from the autonomous driving mode to the manual driving mode.

3. The vehicle of claim 2, wherein the alert notifies a driver of the vehicle to be prepared for the manual takeover event prior to the transfer of the vehicle operation from the autonomous driving mode to the manual driving mode.

4. The vehicle of claim 2, wherein the manual takeover event is when an undesirable condition is determined for the vehicle operation in the autonomous driving mode.

5. The vehicle of claim 1, wherein the communication device is a wearable device.

6. The vehicle of claim 1, wherein the communication device is a portable electronic device.

7. The vehicle of claim 6, wherein the portable electronic device is from a group of a smart phone, a tablet, and a laptop.

8. The vehicle of claim 1, wherein the alert is a notification displayed on the communication device.

9. The vehicle of claim 1, wherein the alert to the communication device is a navigational information.

10. The vehicle of claim 9, wherein the navigational information includes a vehicle estimated time of arrival at a destination is extended due to the vehicle environment information.

11. The vehicle of claim 9, wherein the navigational information includes a notification when the vehicle opts to take a different navigational route.

12. The vehicle of claim 1, wherein the alert includes a plurality of statuses relating to the vehicle environment information and an internal operation of the vehicle.

13. The vehicle of claim 1, wherein the alert includes a user input to control a plurality of vehicle functions.

14. The vehicle of claim 13, wherein the plurality of vehicle functions includes an increase in a vehicle speed when the vehicle is in the autonomous driving mode.
